(19) United States
(12) Patent Application Publication
(10) Pub. No.: US 2003/0171238 A1
(43) Pub. Date: Sep. 11, 2003

(54) Enzyme compositions in tablet form

(76) Inventor: Harald Sigmund, Efringen-Kirchen (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/344,959

(22) PCT Filed: Aug. 20, 2001
(86) PCT No.: PCT/IB01/01498

(30) Foreign Application Priority Data
Aug. 21, 2000 (GB) 0020379.4

(51) Int. Cl. C12S 9/00; C11D 3/00

(52) U.S. Cl. 510/392; 510/447

(57) ABSTRACT

The invention relates to an enzyme composition in tablet form comprising one or more enzymes, tabletting auxiliaries, effervescent additives and substantially no detergent components, to a process for its preparation and to the use of such enzyme composition for the treatment of textile materials and the use in paper and pulp industry.

The invention relates to an enzyme composition in tablet form, to the process of producing such composition in tablet form and to its use for the treatment of textile materials, for its use in starch industry or for its use in pulp and paper processing.

In this context “enzyme” is defined as a protein, which exhibits a defined performance on particular substrates.

Enzyme compositions in tablet form are well known in the prior art when the enzyme is supposed to have a pharmaceutical application (FR 2305194) or, more commonly, when the enzyme is a minor active ingredient of detergent tablets (EP 851023, WO 97/03177). Furthermore, tablets containing enzymes are mentioned in WO 97/18288, U.S. Pat. No. 4,690,773 and JP 9030956 where protease and/or lipase enzymes are claimed for tablets to be used for cleaning contact lenses. WO 95/00121 discloses a compressible enzyme powder, which may be transformed into tablets, without defining the condition of producing tablets. Furthermore, WO 95/00121 describes the problems when using spray-dried enzyme powder with respect to the allergy potential and overcomes this problem by using the so-called wet-granulation technology.

The object of this invention is to offer enzyme compositions in tablet form containing an effective amount of enzyme, characterized in that the tablets are formed by using enzymes in powder form. The essence of this invention is to convert the crude enzyme powder into a compressible mixture without using any of the so-called wet granulation technologies described in detail in WO 95/00121 and to convert this mixture into tablets.

A further object of the invention is to obtain inventive enzyme tablets with an improved dissolution time, respectively a good dissolution in liquids, preferably in water. In the abovementioned WO 95/00121, the tablets, which have a weight of 430 mg, have a dissolution time in water of 5 or 6 min respectively under 10 min at a temperature of 37° C., whereas the dissolution time in water of the tablets of the present invention is under 5 min at a lower temperature than 37° C., preferably at 25° C. In the case that the dissolution is measured the dissolution in water is preferably between 80% and 100% after a period of 2 min. at 25° C. The detailed description of the method for determining the dissolution is described below.

According to the present invention, such tablets are storage stable for up to 6 months, even at temperatures of 40° C. without a loss of more than 10% activity, although acidic components, necessary for the effervescent system, are incorporated into the tablet and no starch, sugar, sugar alcohol or mixtures thereof are comprised. This is surprising, because U.S. Pat. No. 3,515,642, which is also cited in WO 95/00121, teaches that stabilizing compounds like sorbitol are necessary to obtain storage stable tablets.

The combination of enzyme protein other than lipase or protease with acidic components in such a highly compressed system is new and the storage stability of such tablets is surprisingly good, because the state of the art (WO 97/23606) teaches that often scavenger layers and special coatings are necessary to produce i.e. stable enzyme containing granules. Granules or tablets which contain no multi-layer system as described in WO 97/23606 are not very storage stable and are damaged in the presence of an acidic system.

The tablets according to this invention contain an effective amount of enzyme, such as e.g. cellulase, hemicellulase, xylanase, pectinase, peroxidase, laccase or any other oxido-reductase or other enzymes relevant for the use in starch, textile or pulp and paper processing. An effective amount of enzyme is defined by the amount of enzyme necessary to reach the desired application effect. Compared to the above mentioned non-textile applications of the prior art, this amount of enzyme is generally significantly higher.

The invention, therefore, relates to an enzyme composition in tablet form comprising one or more enzymes, tabletting auxiliaries, disintegrating systems and substantially no solid or solidified detergent components, in which starch, sugar, sugar alcohol or mixture of such ingredients is contained.

The enzymes can be of natural origin or they can be genetically engineered or modified by protein engineering.

Preferably, the enzyme is cellulase, which can be of natural origin or genetically engineered or modified by protein engineering.

The enzyme is incorporated into the composition as a solid or solidified protein and it is preferably but not exclusively the product of spray-drying of the fermentation broth of a drying a protein containing solid obtained by precipitation of protein from a concentrated fermentation broth or fermentation extract (solid state fermentation) by various methods as described in the literature.

Examples of commercially available cellulases are for example products of Novo Nordisk sold e.g. under the trade name “Denimax”, cellulase products from Genencor International sold e.g. under the trade name “Indiage” or “Primafast”, cellulase products from Iogen Corporation sold e.g. under the trade name “Denabride”, cellulase products of Dyadic Industries International, sold e.g. under the trade name “Rocksoft”, cellulase products of Rohm Enzyme Finland sold e.g. under the trade name “Ecostone”, cellulase products from Meiji Seika Keisha, cellulase products from Ralcuto Kasai, cellulase products from Clariant as described for example in EP 921188.

The amount of enzyme present in the tablet composition of the invention can vary widely. It depends on the activity of the used enzyme and it is very much related to the purity of the enzymatic protein contained in the material. The protein content of any enzyme containing material is determined using a modified bichioninic acid assay (R. E. Brown, Anal. Biochem 180 (1989), p. 136). Any commercially available material is therefore defined as ECM (“enzyme-containing material”), since often additives arc added to the protein to commercialize the product.

If a ECM with high protein content is used or if the purity of the enzyme is high, i.e. when the enzyme is produced by means of genetic engineering, the enzyme content of the tablet may vary from 0.1 to 5 weight-% (wt-%) ECM relating to the weight of the tablet, because the enzyme is very efficient. If the ECM of spray-drying of the unpurified fermentation broth, i.e. a ECM with a larger content of non-active protein material (inactive with respect to the particular application), or a mixture of more active and less active enzymes is used, the ECM-content has to be at least 10 wt-% but can be as high as 90 wt-% relating to the weight of the tablet. In practice, except when very pure enzymes are used, the content is 2 to 30 wt-%. When very pure enzymes are used the content can be as low as 0.0001 wt-% ECM.

Tabletting auxiliaries, which are frequently called excipients, are well known in the prior art and comprise e.g. binders, flow-aids, disintegrants and lubricants. The purpose of the binder and/or disintegrant is to hold together the ingredients of the tablet, but still allows the dissolution in the treatment liquor, which is preferably water. Incorporation of a binder also allows the use of lower compaction pressures, which also supports the disintegration of the tablet in the treatment liquor. Lower compaction pressure means higher throughput during processing of tablets while the probability of mechanical breakdown of parts due to high stress is decreased. Variable compaction pressures are furthermore important to take account of different stability properties of varying enzymes towards the mechanical stress during the formation of the tablet. The binder and/or disintegrant should, however, be compatible with the high amount of enzyme present in the tablets and not interfere with the treatment process of textile materials in which the tablets are used.

Examples of suitable materials are all types of cellulose and cellulose derivatives, micro-crystalline cellulosic fibers, micro-crystalline cellulose, methyl-cellulose, hydroxypropyl-cellulose and all types of clays etc.

Examples of commercially available products are Avicel®, Vivapur®, Arbocel®, Lignocell®, ECC China clay (as an example for all types of clays) and all types of chemically modified natural carbohydrates e.g. products of Clariant under the trade name Tylosec®.

Other tablet additives used as lubricants are e.g. stearates, waxes, hydrogenated vegetable oils, solid ethoxylated fatty alcohols, solid ethoxylated fatty amines, solid ethoxylated fatty acids, and polyethylene glycols.

Therefore, a further embodiment of the invention is an enzyme composition as described above, in which the tabletting auxiliaries comprise a carrier such as cellulose, cellulose derivatives, a binder such as polyethyleneglycol or higher ethoxylated fatty alcohol derivatives, a lubricant and/or a disintegrant.

Optional components are fillers such as sodium sulfate, sodium chloride and other non-reactive salts, liquid tensioactive agents (in minor amounts) and antifoaming agents.

Liquid tensioactive agents are for example ethoxylated alcohols of the general formula CₙH₂ₙO(CH₂CH₂O)ₘOCH₂CH₂OH, wherein n goes from 6 to 30, preferably from 9 to 18 and m from 1 to 20, preferably from 2 to 10. Such compounds are commercially available under the trade marks Lutensol® from BASF or Genapol® from Clariant.

Antifoaming agents are for example silicon defoamers from Wacker-Chemie GmbH or Th. Goldschmitt GmbH, e.g. Wacker silicon antifoam S 385 or Wacker silicon antifoam S 369, Wacker silicon antifoam S 882, or Wacker silicon antifoam SE 2, which are commercially available.

For the good dissolution of the tablets in liquids, preferably in water, it is also common to incorporate a chemically based disintegrating system e.g. effervescent systems. This includes solid acids or acid salts such as citric acid, maleic acid, tartaric acid, oxalic acid, adipic acid, alkali and/or other metal hydrogen phosphates, including all types of ammonium hydrogen phosphates, in combination with a basic ingredient that evolves carbon dioxide when interacting with this acid source. Examples include sodium and potassium carbonate and bicarbonate and sodium sesquicarbonate. Other (physical) disintegrating systems are based on material swelling after contact with water and causing this way a physical breaking of the tablet. Examples of such physical disintegrants are described in detail e.g. in EP 1043389, WO 98/40463 or DE-A4404279.

An object of the instant invention is an enzyme composition in tablet form produced by mixing the crude enzyme powder and the other ingredients in dry powder form and compressing the mixture in a suitable die, said composition comprising

a) one or more enzymes selected from cellulase, hemicellulase, xylanase, pectinase, peroxidase, laccase or other oxido-reductase,

b) a disintegrating system comprising an effervescent system or a combination of an effervescent system with a mechanically based disintegrating system (swelling mechanism), in which the effervescent system consists of a solid acid or one or more of its salts and a basic ingredient that evolves carbon dioxide when interacting with acid, and

c) tabletting auxiliaries.

In order to safeguard the stability of the enzymes in the composition a buffer system can be included to keep the pH value in a given range, where the enzyme system is stable. Such a buffer system can be identical with the effervescent components or it can comprise any mixtures of phosphates, borates or organic acids or bases, which may form salts.

Not all solid acids can be used as an acid donor in enzyme tablets.

Preferably, the solid acid should not contain any crystalline bound water or show hygroscopic behavior.

More preferably, adipic acid and all salts of alkali and other metal hydrogen phosphates, including all types of ammonium hydrogen phosphates are used.

Preferred amounts of the various components in the enzyme tablet are:

0.1 to 90 wt.-% ECM, depending on purity and strength of the particular protein,

10 to 90 wt.-% tabletting auxiliaries binder and/or disintegrant),

5 to 90% wt.-% effervescent components and buffer,

based on the weight of the total composition.

A preferred embodiment of the present invention is an enzyme composition as described above comprising 0.1 to 90 wt.-% ECM, 10 to 90 wt.-% tabletting auxiliaries, 5 to 90 wt.-% effervescent components and optional further components. The weight percentages are related to the weight of the tablet.

The enzyme compositions in tablet form according to the invention can be prepared by well known tabletting processes. In principle, the ingredients are mixed homogeneously in dry form, optionally with the help of dedusting agents. The ingredients are mixed with flow-aids and finally compressed in a suitable die at conventional pressures. Suitable pressure conditions are described below. It is obvious for the skilled person in the art that high pressure as well as high temperature may denaturate the enzyme and therefore such conditions should be avoided.

The enzyme compositions in tablet form according to the invention are used for the treatment of textile materials, more specifically in processes where such textile materials are treated with enzymes to give them a special appearance such as e.g. stone washed-look.

Preferably, pectinase compositions are used for the so called “biosouring” process of textiles to remove pectic compounds, which are present i.e. in untreated cotton.

Preferably, cellulase compositions are used for the treatment of cotton, more specifically denim materials to give them the so-called “stone-washed” appearance. In such processes, the tablets are dissolved in the treatment bath to obtain the usual concentration of enzyme to achieve the desired effects, which can be either effects on the surface to modify the handle or the aspect or to pretreat textile material for further processing. For the treatment of denim and other cotton materials, the concentration, which has to be used to obtain a visible effect of a surface modification depends on the quality of the active cellulase protein as described below.

The following examples will illustrate the broad range of dosages of various commercially available ECM containing cellulase proteins. In the following the amounts are given in relation to the fabric as % owg (on weight of garment).

In case of Denimax® BT 0.1% owg to 10% owg, preferably between 0.2% and 2% owg are used.

In case of Denimax® 501 S 0.05% owg to 5% owg, preferably between 0.1% and 2% owg are used.

In case of Denimax® 399 S 0.01% owg to 5% owg, preferably between 0.05% and 1% owg are used.

In case of Denimax® 991 S 0.02% owg to 5% owg, preferably between 0.1% and 2% owg are used.

In case of IndiAge® Super GX 0.015% owg to 5% owg, preferably between 0.1% and 2% owg are used.

In case of IndiAge® Neutra G 0.01% owg to 5% owg, preferably between 0.05% and 1% owg are used.

In case of Denabride LBG® 0.05% owg to 5% owg, preferably between 0. 1% and 2% owg are used.

In case of Meiji Cellulase HEP 100® 0.0001% owg to 0.5% owg, preferably between 0.0005% and 0.05% owg are used.

In case of Meiji Cellulase ENM 3064® 0.0001% owg to 0.5% owg, preferably between 0.0005% and 0.05% owg are used.

In case of Rocksoft Ultra P® 0.001% owg to 5% owg, preferably between 0.01% and 0.5% owg are used.

In case of Rocksoft NCE EA® 0.001% owg to 5% owg, preferably between 0.01% and 0.5% owg are used.

In case of Ecostone NGC 1600® 0.001% owg to 5% owg, preferably between 0.01% and 0.5% owg are used.

From these examples it is obvious, that the amount of the ECM used in the tablets according to the present invention cannot be defined within a narrow range. The performance depends on the nature and on the purity of the ECM. The ultimate dosage can only be determined by tests which are close to the real application conditions, i.e. the “Clariant test method for measurement of jeans wash effect”, Revision 0 dated 28^{th} of September 1999, which is available from the applicant upon request.

The advantage of using enzyme compositions in tablet form is to be seen in the easy handling, fast disintegration time, the improved storage stability and the exact and easy dosage of the enzyme system.

Detailed description of tablet production:

A. Production of Directly Compressible Mixture

In the process of invention the enzyme mixtures (Table 1) may be made in accordance with well-known mixing procedures for instance by using a high shear mixer e.g. by a Lödige® mixer. Contradictory to the wet granulation technology used in WO 95/00121, where a liquid enzyme preparation is used, the present invitation uses dry ECM and avoids the dusting problem by pretreatment with dedusting agents in combination with dust removal by suction. Dedusting agents may consist of a carrier material which is pretreated with a preferably waterfree liquid, which is not affecting the enzyme activity. The carrier is a chemically not aggressive substance, able to uptake the waterfree liquid and to form a homogeneous compound together with the liquid and enzyme. Preferably, the carrier is cellulosic material with a low density and high surface. The waterfree liquid is also a chemically not aggressive substance, preferably a nonionic, water dissolving liquid with a boiling point higher than 70° C. (1 atm). Preferably, but not exclusively the liquid is a polyethylenoxide derivative, like polyethyleneglycol with a molecular weight below 2000D, i.e. Polyethyleglycol 400 or a polyethyleneglycolether, polyethyleneglycolester, polyethyleneglycol-carbonate with the same molecular weight. Afterwards, the mixture of carrier and ECM is mixed with the other tabletting ingredients to form a homogenous mixture for tabletting.

B. Tabletting Procedure

The above described mixture is converted into tablets by using a common tabletting machine, e.g. Rundläufer PH 400 of Fa. Korsch. The form of the tablet may have any form such as cylindrical, cubic, cuboid or spherical. Preferably it is in the form of a cylinder. The art of the tabletting producing technology is described in EP 871698. The tabletting mixture should contain only traces of water. The water content (humidity) is determined by a Mettler Toledo® Typ LJ 16 moisture Analyzer. The moisture content should be below 2 wt.-% relating to weight of the mixture, preferably below 1 wt.-%. The pressure may vary between 10 and 90 kN, preferably between 25 and 75 kN. The obtained tablets exhibit a hardness of 2 to 20 kp, preferably between 3 and 15 kp and most preferably between 4 and 10 kp. The diameter of the cylindrical tablets is 10 to 60 mm, preferably 20 to 50 mm, most preferably 35 to 45 mm. The weight of such tablets is 1 to 100 g, preferably 10 g to 50 g. The height of such tablets may vary between 5 and 30 mm depending on the diameter of the punches, the composition of the mixture and the pressure. The dissolution time of such tablets in liquids, preferably in water depends on the formulation ingredients, the pressure, the weight and the diameter of the punches used. The before mentioned parameters are adjusted to obtain tablets with a dissolution time of less than 5 min at a temperature of 25° C., determined directly after production using a tablet tester (Model Dr. Schleuniger®, Typ 6D tablet tester). The dissolution behavior of the tablets is determined in dependence of the storage time. The tablets of the invention have a dissolution time of less than 5 min., which was measured directly (less than 24 hours) after the production. After storage of the tablets for 2 months at room temperature the dissolution time may increase up to 7 min. After storage of the tablets for 2 months at room temperature the dissolution time may increase up to 10 min. Preferred in general are tablets which show at any storage temperatures up to 40° C. dissolution times of less than 5 min.

Determination of Dissolution Time:

1 l of water is placed into a 3 l beaker at 25° C. Under stirring using a magnetic stirrer and an agitator of 6 cm length and with a diameter of 1 cm at stirring speed of 500 rpm (round per minute), the tablet is placed into the beaker. After 2 min, the content of the beaker is poured through a metal sieve (pore size 1 mm), the optionally resulting tablet residue is collected and dried. The dissolution behavior is expressed in % of the original weight of the tablet after 2 min, at 25° C.

C. Preparation of Tablets in the Laboratory

In order to optimize the formulation ingredients, tablets in the lab are produced using a Perkin Elmer press for making IR pressings or laboratory press systems from Paul-Otto Weber GmbH (D-73630 Remshalden, Germany).

The following examples illustrate the invention. In the examples all parts and percentages are by weight unless indicated to the contrary, and all temperatures are given in degrees Centigrade.

### EXAMPLES 1-4

20 wt.-% dried cellulose is homogeneously mixed using a “Lödige” mixer with 5 wt.-% polyethylenegycol 400 and 5 wt.-% silicon defoamer (Wacker silicon antifoam S 385) for at least 15 min to produce an in situ carrier system. To this mixture 5-20 wt.-% spray dried ECM-powder or a mixture of various ECM is added using a vacuum system to avoid any occurring dust. The mixture is immediately distributed on the surface of the carrier. To this mixture 50-65 wt.-% sodium bicarbonate is added. This mixture is finally mixed thoroughly in a “Lödige” mixer with the other tabletting auxiliaries. Table 1 gives examples for such compositions. These compositions are used to form cylidrical tablets with a weight of 25 g and a diameter of 38 mm and a height of 17 mm and a hardness of 6 kp±0.5 kp.

TABLE 1
Example 1-4

| Exp. | ECM1 | ECM2 | carbonate | solid acid 1 | solid acid 2 | lubricant | disintegrant | dissolution* |
|---|---|---|---|---|---|---|---|---|
| 1 | 10% prepared | 15% Indi Age | 31% sodium | 15% adipic acid | 14% monoammonium- | 5% Genapol | 10% Arbocel | 100% |
| | from HEP 100 | Neutra G | bicarbonate | | phosphate | T800 | TG30 HG | (less than 2 min) |
| 2 | 10% prepared | 5% Indi Age | 31% sodium | 15% adipic acid | 19% monoammonium- | 10% Genapol | 10% Arbocel | 100% |
| | from HEP 100 | Neutra G | bicarbonate | | phosphate | T800 | TG30 HG | (less than 2 min) |
| | and ENM 3064 | | | | | | | |
| 3 | 10% prepared | 5% Denabide | 36% sodium | 15% adipic acid | 17% monoammonium- | 7% Genapol | 10% Arbocel | 100% |
| | from ENM 3064 | LBG | bicarbonate | | phosphate | T800 | TG30 HG | (less than 2 min) |
| | and NCE EA | | | | | | | |
| 4 | 10% prepared | 10% Denimax | 36% sodium | 12% adipic acid | 17% monoammonium- | 10% Genapol | 5% Arbocel | 80% |
| | from HEP 100 | 991 S | bicarbonate | | phosphate | T800 | TG30 HG | |
| | and NCE EA | | | | | | | |

*determined within 24 h after press process (storage at 25° C.)

Application

A tablet as produced using the process of the present invention may be used in the application at a dosage of 0.01% to 1% owg, depending on the desired degree of abrasion and application time. In a rotary drum washer, 3 kg of desized jeans are treated with at pH 5-7 with 0.1% owg of the above mentioned tablets for 60 min at 55° C. The jeans are finally rinsed and dried for evaluation. The degree of wash-down depends on the tablet composition.

1. An enzyme composition in tablet form produced by mixing the crude enzyme powder and the other ingredients in dry powder form and compressing the mixture in a suitable die, said composition comprising
a) one or more enzymes selected from cellulase, hemicellulase, xylanase, pectinase, peroxidase, laccase or other oxido-reductase,
b) a disintegrating system comprising an effervescent system or a combination of an effervescent system with a mechanically based disintegrating system (swelling mechanism), in which the effervescent system consists of a solid acid or one or more of its salts and a basic ingredient that evolves carbon dioxide when interacting with acid, and
c) tabletting auxiliaries.

2. An enzyme composition according to claim 1 characterized in that the effervescent system consists of citric acid, maleic acid, tartaric acid, oxalic acid, adipic acid, alkali and/or other metal hydrogen phosphates, including all types of ammonium hydrogen phosphates, in combination with a basic ingredient that evolves carbon dioxide when interacting with this acid source.

3. An enzyme composition according to claim 1 or 2 in which the tabletting auxiliaries comprise a carrier such as cellulose, cellulose derivatives, a binder such as polyethyleneglycol or higher ethoxylated fatty alcohol derivatives, a lubricant and/or a disintegrant.

4. An enzyme composition according to any one of the preceding claims comprising 0.1 to 90% by weight enzyme, 10 to 90% by weight tabletting auxiliaries, 5 to 90% by weight effervescent components and optional further components.

5. Process for the preparation of an enzyme composition according to any one of the preceding claims by mixing the crude enzyme powder and the other ingredients in dry powder form and compressing the mixture in a suitable die.

6. Process for the preparation of tablets comprising an enzyme composition according to claims 1-4 which have dissolving times less than 5 minutes and exhibit a hardness between 2 and 20 kp after compressing.

7. Use of an enzyme composition according to any one of the preceding claims for the treatment of textile materials, for use in starch processing industry or for the use in the pulp and paper industry.

8. Use according to claim 7 by dissolving the tablet comprising the enzyme composition in an aqueous treatment bath or predissolving it in water before addition to the aqueous treatment bath.
